(19) United States
(12) Patent Application Publication
(10) Pub. No.: US 2015/0168300 A1
(43) Pub. Date: Jun. 18, 2015

(54) ARTICLE AND PROCESS FOR MODIFYING LIGHT

(71) Applicant: NATIONAL INSTITUTE OF STANDARDS AND TECHNOLOGY, GAITHERSBURG, MD (US)

(72) Inventors: ALEXANDER W. PETERSON, WASHINGTON, DC (US); ANNE L. PLANT, WASHINGTON, DC (US); MICHAEL HALTER, BETHESDA, MD (US)

(21) Appl. No.: 14/607,290

(22) Filed: Jan. 28, 2015

Related U.S. Application Data
(60) Provisional application No. 61/932,496, filed on Jan. 28, 2014.

(51) Int. Cl. G01N 21/552

(52) U.S. Cl. CPC G01N 21/553

(57) ABSTRACT

An article to perform surface plasmon resonance imaging includes a light source to provide source light, the source light including a source optical profile, the source optical profile being selected to match a transmission profile at a surface plasmon resonance angle; an optical transformer configured to: receive the source light from the light source; and produce a transformed light comprising the source optical profile; and an optical modifier including: a back focal plane disposed at a first surface of the optical modifier and including the transmission profile; and an image focal plane disposed at a second surface of the optical modifier opposing the back focal plane, the optical modifier being configured to: magnify the transformed light; and produce magnified transformed light that includes the source optical profile.

### CROSS REFERENCE TO RELATED APPLICATIONS

The present application claims the benefit of U.S. Provisional Patent Application Ser. No. 61/932496 filed Jan. 28, 2014, the disclosure of which is incorporated herein by reference in its entirety.

### STATEMENT REGARDING FEDERALLY SPONSORED RESEARCH

This invention was made with United States government support from the National Institute of Standards and Technology. The government has certain rights in the invention.

### BACKGROUND

Biological imaging has improved diagnostic capabilities in research and clinical settings. Fluorescence techniques of biological samples involve detection of a fluorescent signal as well as imaging a biological sample labeled with a fluorescent tag.

The art is receptive to articles and processes that provide optical detection of materials.

### BRIEF DESCRIPTION

The above and other deficiencies are overcome by, in an embodiment, an article to perform surface plasmon resonance imaging comprising: a light source to provide source light, the source light comprising a source optical profile, the source optical profile being selected to match a transmission profile at a surface plasmon resonance angle; an optical transformer configured to: receive the source light from the light source; and produce a transformed light comprising the source optical profile; and an optical modifier comprising: a back focal plane disposed at a first surface of the optical modifier and comprising the transmission profile; and an image focal plane disposed at a second surface of the optical modifier opposing the back focal plane, the optical modifier being configured to: magnify the transformed light; and produce magnified transformed light comprising the source optical profile.

Further disclosed is a process for modifying a source light, the process comprising: receiving a source light comprising a source optical profile at an optical transformer; producing a transformed light comprising the source optical profile; communicating the transformed light from the optical transformer to an optical modifier that comprises: a back focal plane; and an image focal plane opposing the back focal plane; magnifying the transformed light; producing a magnified transformed light comprising the source optical profile from the transformed light to modify the source light; and transmitting the magnified transformed light at a surface plasmon resonance angle at the image focal plane.

### BRIEF DESCRIPTION OF THE DRAWINGS

The following descriptions should not be considered limiting in any way. With reference to the accompanying drawings, like elements are numbered alike:

FIG. 1 shows an embodiment of an article; and

FIG. 2 shows an embodiment of an article;

FIG. 3 shows light paths in the embodiment of the article shown FIG. 2;

FIG. 4 shows an embodiment of an article;

FIG. 5 shows light paths in the embodiment of the article shown FIG. 4;

FIG. 6 shows a cross-section of an optical modifier, substrate, and layer;

FIG. 7 shows a graph of reflected intensity and radial position on back focal plane versus angle of incidence;

FIG. 8 shows a linearly polarized transformed light incident on a back focal plane of an optical modifier;

FIG. 9 shows a back focal plane of an optical modifier;

FIG. 10 shows a graph of reflectivity and x-axis radial position versus angle;

FIG. 11 shows a source light optical profile on a back focal plane of an optical modifier;

FIG. 12 shows a radially polarized transformed light incident on a back focal plane of an optical modifier;

FIG. 13 shows a source light optical profile on a back focal plane of an optical modifier;

FIG. 14 shows a magnified sample light incident on a back focal plane of an optical modifier according to Example 7;

FIG. 15 shows a graph of reflectivity versus angle according to Example 7;

FIG. 16 shows a source light optical profile on a back focal plane of an optical modifier according to Example 7;

FIGS. 17A, 17C, 17E, 17G show surface plasmon resonance images for various cell types according to Example 8;

FIGS. 17B, 17D, 17F, 17H show phase contrast images for various cell types according to Example 8;

FIG. 18A shows a surface plasmon resonance image for a polymer microsphere according to Example 9;

FIG. 18 B shows a graph of change in reflectivity AR versus distance for data from the image shown in FIG. 18A according to Example 9;

FIG. 18C shows a fluorescence image for a polymer microsphere according to Example 9;

FIG. 18 D shows a graph of change in reflectivity AR versus distance for data from the image shown in FIG. 18C according to Example 9;

FIG. 19A shows images for a polymer microsphere according to Example 10;

FIG. 19B shows a model for determining depth of surface plasmon resonance imaging according to Example 10;

FIG. 19C shows a model for determining background signal in surface plasmon resonance images according to Example 10;

FIG. 19D shows a graph of intensity versus distance from a surface of a sample according to Example 10; and

FIG. 19E shows a graph of penetration depth versus excitation wavelength according to Example 10.

### DETAILED DESCRIPTION

A detailed description of one or more embodiments is presented herein by way of exemplification and not limitation.

It has been discovered that an article configured for surface plasmon resonance imaging through a microscope objective has near diffraction limited spatial resolution of refractive index changes at the sensor interface. The article can include a digital light projector as a spatial light modulator to select specific angles of incident light to couple with surface plasmons in combination with an optical set-up to project a selected optical profile onto a back focal plane of the microscope objective. Advantageously, the article provides spatial resolution for imaging of molecular scale variations at surfaces. Moreover, samples for imaging include numerous materials that affect refractive index at a surface that the material contacts, e.g., a sample such as patterned alkanethiols that include different spatial density, focal adhesions (i.e., regions of high protein density) underneath a cell membrane, and the like. Furthermore, the sample subject to surface plasmon resonance imaging by the article does not need to include a fluorescence label since imaging of the sample is due to a contrast in reflected light due to refractive index changes that affect reflectivity of a layer that produces an evanescent wave from surface plasmons that interact with the sample as described herein.

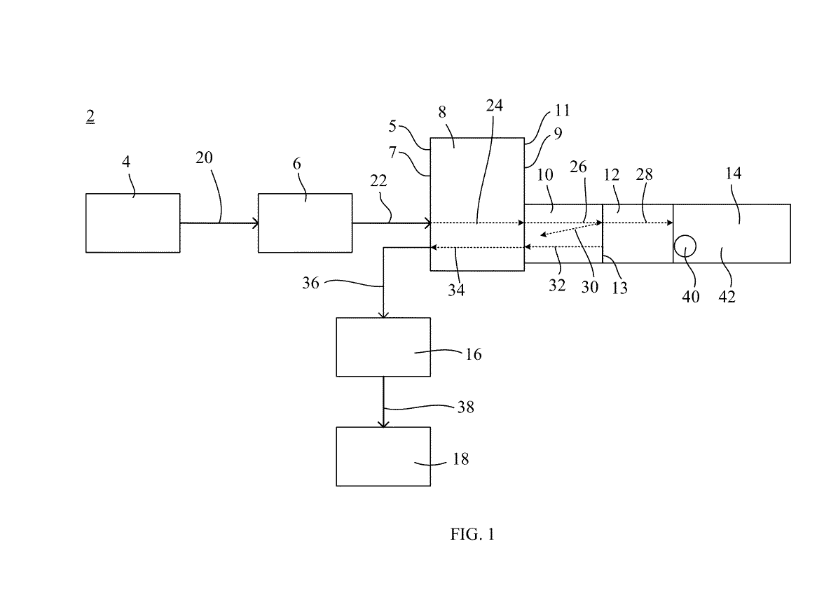

In an embodiment, as shown in FIG. 1, article 2 is configured to perform surface plasmon resonance imaging of a sample and includes light source 4 to produce source light 20 that propagates to optical transformer 6. Optical transformer 6 is configured to produce transformed light 22 from source light 20. Transformed light 22 propagates from optical transformer 6 to optical modifier 8. Optical modifier 8 includes first surface 5 upon which transformed light 22 is received at back focal plane 7. Optical modifier 8 is configured to magnify transformed light 22 that propagates along path 24 in optical modifier 8 and to produce magnified transformed light 26 that is communicated to image focal plane 9 at second surface 11. Magnified transformed light 26 is received by substrate 10 and is transmitted to an optical interface 13 between substrate 10 and layer 12 disposed on substrate 10. At optical interface 13, magnified transformed light 26 is reflected by layer 12 if magnified transformed light 26 is not propagating at a surface plasmon resonance angle with respect to layer 12. Alternatively, at optical interface 13, magnify transformed light 26 that propagates at the surface plasmon resonance angle with respect to layer 12 is coupled to surface plasmons of layer 12 to produce evanescent wave 28 by layer 12. Sample 14 is disposed on layer 28 to receive evanescent wave 28. Sample 14 can have an inhomogeneous refractive index such that portions of sample 14 proximate to layer 28 have different refractive indices. In an embodiment, sample 14 includes analyte 40 disposed in matrix 42. Here, it is contemplated that analyte 40 and matrix 42 have different refractive indices that affect interaction with or production of evanescent wave 28. Without wishing to be bound by theory, it is believed that a change in refractive index of sample 14 due to analyte 40 in matrix 42 causes variations an effective reflectivity of layer 12 with respect to incident magnified transformed light 26. In this manner, interaction of evanescent wave 28 with sample 14 produces sample light 32 that includes an intensity that varies due to refractive index of sample 14 probed by magnified transformed light 26.

Sample light 32 is communicated through substrate 10 and communicated to optical modifier 8 at image focal plane 9. Optical modifier 8 magnifies sample light 32 to produce magnified sample light 34 that is incident at back focal plane 7. Image light 38 is communicated to detector 18 via selector 16 that receives light from optical modifier 8. Selector 16 is configured to provide detector 18 sample light 32 from image focal plane 9 or magnified sample light 34 from back focal plane 7. Accordingly, image light 38 includes sample light 32 from image focal plane 9 or magnified sample light 34 from back focal plane 7.

According to an embodiment, article 2 is configured to perform surface plasmon resonance imaging and includes light source 4 to provide source light 20, which includes a source optical profile. The source optical profile is selected to match a transmission profile at a surface plasmon resonance angle. Article 2 also includes optical transformer 6 configured to receive source light 20 from light source 4 and produce transformed light 22 that includes the source optical profile. Article 2 further includes optical modifier 8 that includes the transmission profile and back focal plane 7 disposed at first surface 5 of optical modifier 8 and image focal plane 9 disposed at second surface 11 of optical modifier 8 opposing back focal plane 7. Optical modifier 8 is configured to magnify transformed light 22 and produce magnified transformed light 26 that includes the source optical profile. As used herein, “magnify” (and variants thereof, e.g., magnification) refers to modifying an optical size of an object and can be quantified by a numerical quantity such as magnification. When the magnification is less than one, the optical size of the object is reduced (sometimes referred to as “minification” or “de-magnification”). When the magnification is greater than one, the optical size of the object is increased.

Here, optical modifier 8 further is configured to communicate magnified transformed light 26 from back focal plane 7 to image focal plane 9 and to focus magnified transformed light 26 onto image focal plane 9 such that magnified transformed light 26 is incident at image focal plane 9 at the surface plasmon resonance angle. In some embodiments, article 2 further includes substrate 10 disposed on the optical modifier 8 and layer 12 disposed on substrate 10, wherein substrate 10 is configured to receive magnified transformed light 26 from optical modifier 8 and to communicate magnified transformed light 26 to layer 12. Layer 12 is configured to produce evanescent wave 28 in response to receiving magnified transformed light 26 at the surface plasmon resonance angle and to reflect light (e.g., magnified transformed light 26) incident at image focal plane 9 at an angle different than the surface plasmon resonance angle. In a certain embodiment, article 2 sample 14 disposed on layer 12 to interact with evanescent wave from layer 12. Sample 14 is configured to produce sample light 32 that includes the sample optical profile in response to interacting with evanescent wave 28 from layer 12.

Optical modifier 8 is configured to receive sample light 32 from sample 14, to magnify sample light 32, and to communicate magnified sample light 34 to 18 detector, which is configured to receive magnified sample light 34 from optical modifier 8.

Light source 4 provides source light 22 having a source optical profile that matches the transmission profile of back focal plane 7 of optical modifier 8. The transmission profile corresponds to a shape of light that, when incident at the surface plasmon resonance angle at image focal plane 9, couples to layer 12 disposed on substrate 10 and excites surface plasmons to produce evanescent wave 28. Light that does not match the transmission profile or that is not at the surface plasmon resonance angle at image focal plane 9, does not produce evanescent wave 28 and is reflected by layer 12. In an embodiment, light source 4 directly produces source light 22 that has the source optical profile that matches the transmission profile of back focal plane 7. That is, a shape of the source optical profile is not modified to match the transmission profile after being produced by light source 4. In another embodiment, light source 4 indirectly produces source light 22 that has the source optical profile that matches the transmission profile of back focal plane 7. That is, a shape of the source optical profile is modified to match the transmission profile after being produced by light source 4; such modification of the shape of the source optical profile to match the transmission can be accomplished transmitting source light 20 through an aperture, reflecting source light 20 from a mirror, and the like.

With regard to a shape of the transmission profile of back focal plane 7, in an embodiment, the transmission profile of back focal plane 7 has an asymmetric shape, and the light source 4 is configured to produce source light 20 such that the source optical profile is asymmetric to match the transmission profile at back focal plane 7. In a particular embodiment, the transmission profile of back focal plane 7 has a symmetric shape, and light source 4 is configured to produce source light 20 such that the source optical profile is symmetric to match the transmission profile at back focal plane 7.

Exemplary light sources 4 include a digital light source, analog light source (e.g., a lamp, bulb, and the like), or a combination thereof The digital light source can be a digital light projector. A controller can be provided to control light source 4. In an embodiment, light source 4 is a digital light projector controlled by a controller. The controller can include a processor to provide instructions to the digital light projector to command production of the source optical profile by the digital light projector. Additionally, the controller can control on on-time, off-time, modulation, or color of source light 20.

As used herein, “optical profile” refers to a shape of light projected on a surface. Moreover, matching a first optical profile to a second optical profile (e.g., source optical profile matched to transmission profile) refers to the first optical profile having a shape that is substantially identical to the second optical profile. As such, the source optical profiled has a shape that is substantially identical to the transmission profile of back focal plane 7.

Source light 20 is communicated from light source 4 to optical transformer 6 that produces transformed light 22 from source light 20. Optical transformer 6 can include a first objective lens, a collimating lens, a filter, a polarizer, a tube lens, a beam splitter, or a combination thereof. It will be appreciated optical transformer 6 conserves the source optical profile in source light 20 and transformed light 22.

The first objective lens can be disposed proximate to the light source to focus source light 20 and can have a magnification (e.g., two times (2×), 4×, 10×, 60×, and the like) effective to magnify source light 20 to a size appropriate for communication to optical modifier 8.

The collimating lens collimates source 20, and the filter can selectively transmit a wavelength from source light 20. The filter can be a broadband filter, narrow band, notch filter, neutral density filter, and the like. The beam splitter can be a splitter to reflect source light 20 is transformed light 22 to optical modifier 8 and to transmit sample light 32 or magnified sample light 34 to selector 16 or detector 18.

In this manner, optical transformer 6 transforms source light 22 transformed light 22 and communicates transformed light 22 to optical modifier 8 such that transformed light 22 has the source optical profile.

Optical modifier 8 receives transformed light 22 at back focal plane 7 and magnifies transformed light 22 and produces magnified transformed light 26, which is incident at image focal plane 9. Here, optical modifier 8 can be a second objective lens, e.g., an inverted objective lens, such that transformed light 22 is de-magnified to produce magnified transformed light 26.

Magnified transformed light 26 is transmitted from optical modifier 82 substrate 10. Substrate 10 includes a material that optically transmits magnified transformed light 26 to layer 12 disposed on substrate 10. Substrate 10 can be, e.g., a microscope slide and include glass, plastic, and the like. Layer 12 is selected to produce evanescent wave 28 when subjected to magnified transformed light 26 at the surface plasmon resonance angle of layer 12. Accordingly, layer 12 includes a material that couples its surface plasmons to a wavelength of source light 20, i.e., surface plasmons of layer 12 are presently excited by a wavelength magnified transformed light 26. Exemplary layers 12 include a metal such as gold, copper, nickel, alloys thereof, and the like. Layer 12 can be disposed on substrate 10, e.g., by depositing a metal on substrate 10.

In an embodiment, a substrate is disposed on the optical modifier 8, and a sample is disposed on the substrate such that the layer is not present. That is, the layer is not present to be interposed between the substrate and the sample. Here, the substrate includes an optical material (to transmit the magnified transformed light and sample light) and a dopant disposed in the optical material (e.g., a dopant that is gradiently disposed in the sample). In a particular embodiment, the substrate includes a gradient in the dopant disposed in the optical material such that a concentration of the dopant is greatest proximate to the sample and least proximate to optical modifier 8. In some embodiments, the dopant is substantially absent in the substrate proximate to optical modifier 8. Inclusion of the dopant provides the substrate to receive the magnified transformed light, produce the evanescent wave to interact with the sample (to produce the sample light), and to transmit the sample light to optical modifier 8. Exemplary optical materials include those materials that transmit the magnified transformed light such as quartz and the like. Exemplary dopants include materials that interact with the magnified transformed light to produce the evanescent wave such as metals (e.g., gold, silver, tin, or other transition metals and the like), metalloids (e.g., boron, silicon, germanium, arsenic, antimony, tellurium, carbon, aluminum, selenium, polonium, astatine, indium, and the like).

Evanescent wave 28 produced by layer 12 in response to being subjected to magnified transformed light 26 at the surface plasmon resonance angle interacts with sample 14. Sample 14 can be a pure substance or a composition, e.g., analyte 40 disposed in matrix 42. Moreover, sample 14 can be a homogeneous or inhomogeneous state e.g., a fluid, solid, or a combination thereof. Sample 14 can be a chemical composition, a solid-state material, a biological sample, and the like. In an embodiment, sample 14 includes a cell disposed in an extracellular matrix or medium (e.g., saline, agar, and the like). In another embodiment, sample 14 is a self-assembled monolayer disposed on their 12. In a certain embodiment, sample 14 includes a polymer disposed in a fluid.

In an embodiment, portions of sample 14 proximate to layer 12 have different refractive indices such that these portions cause a variation in a contrast of sample light 32 produced by the interaction of evanescent wave 28 with sample 14. Sample light 32 is transmitted to optical modifier 8 that produces magnified sample light 34 to be transmitted to selector 16 or detector 18.

Selector 16 selectively focuses sample light from image focal plane 9 to detector 18 or magnified sample light 34 from back focal plane 7 to detector 18. Selector 16 includes a mirror (e.g., to reflect light from optical modifier 8), long focal length lens, lenses, filters, and the like. Detector 18 includes a camera (e.g., video camera, CCD, still camera, and the like), photosensor (e.g., photomultiplier tube, photodiode, and the like), ocular, objective lens, or combination thereof.

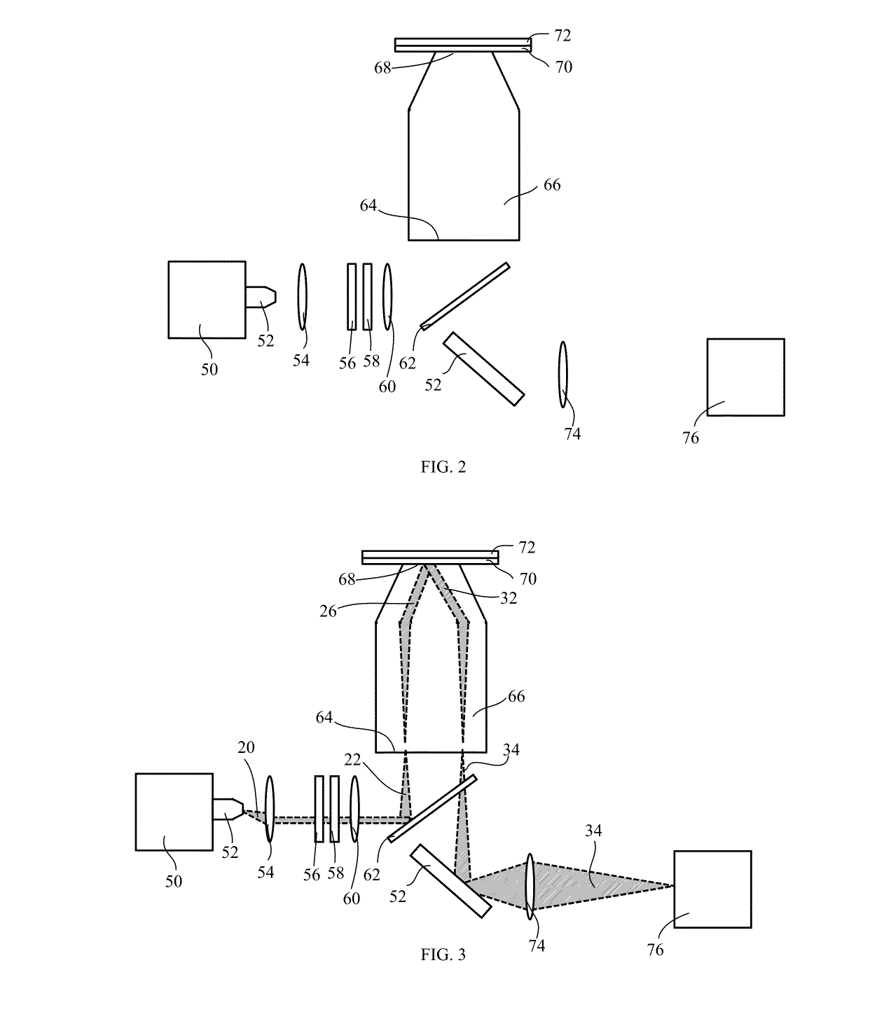

With reference to FIGS. 2 (cross-section of article 2) and 3 (as in FIG. 2 but showing a plurality of light paths), in an embodiment, article 2 includes digital light projector 50 to produce source light 20 that passes through first objective lens 52 and is communicated to collimating lens 54, bandpass filter 56, polarizer 58, short focal length tube lens 60, and pellicle beam splitter 62 to produce transformed light 22. Transformed light 22 is communicated to back focal plane 64 of optical modifier 66 to produce magnified transformed light 26 to be incident on image focal plane 68 and transmitted through substrate 70 to impinge on layer 72. Sample light 32 is communicated from image focal plane 68 to back focal plane 64 of optical modifier 66 to produce magnified sample light 34 that is transmitted through pellicle beam splitter 62 and reflected from mirror 52 through long focal length lens 74 onto CCD detector 76 that detects an image of back focal plane 64.

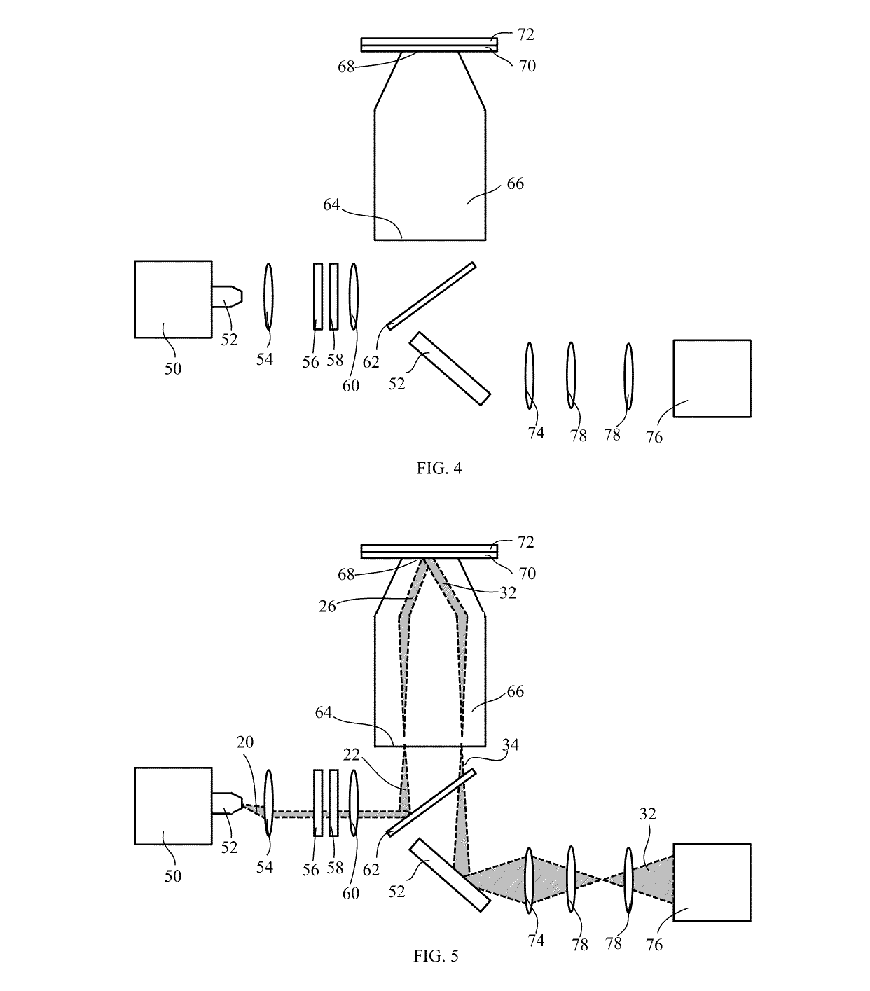

According to an embodiment, with reference to FIGS. 4 and 5 (as in FIG. 4 but showing a plurality of light paths), in an embodiment, article 2 includes digital light projector 50 to produce source light 20 that passes through first objective lens 52 and is communicated to collimating lens 54, bandpass filter 56, polarizer 58, short focal length tube lens 60, and pellicle beam splitter 62 to produce transformed light 22. Transformed light 22 is communicated to back focal plane 64 of optical modifier 66 to produce magnified transformed light 26 to be incident on image focal plane 68 and transmitted through substrate 70 to impinge on layer 72. Sample light 32 is communicated from image focal plane 68 to back focal plane 64 of optical modifier 66 to produce magnified sample light 34 that is transmitted through pellicle beam splitter 62 and reflected from mirror 52 through long focal length lens 74 and lenses 78 onto CCD detector 76 that detects an image of image focal plane 68.

Article 2 has numerous beneficial uses. According to an embodiment, a process for modifying source light 20 or for performing surface plasmon resonance imaging includes receiving source light 20 that includes the source optical profile at optical transformer 6, producing transformed light 22 that includes the source optical profile, communicating transformed light 22 from optical transformer 6 to optical modifier 8 that includes back focal plane 7 and image focal plane 9 opposing back focal plane 7, magnifying transformed light 22, producing magnified transformed light 26 that includes the source optical profile from transformed light 22 to modify source light 20, and transmitting magnified transformed light 26 at the surface plasmon resonance angle at image focal plane 9. The process further includes communicating magnified transformed light 26 to layer 12 disposed on substrate 10, producing evanescent wave 28 on layer 12 from magnified transformed light 26 at the surface plasmon resonance angle, subjecting sample 14 disposed on layer 12 to evanescent wave 28, producing sample light 32 that includes the sample optical profile from sample 14 in response to being subjected to evanescent wave 28, and communicating sample light 32 to optical modifier 8. In some embodiments, the process also includes producing magnified sample light 34 that includes the sample optical profile from sample light 32 by optical modulator 8, communicating magnified sample light 34 from optical modulator 8, and receiving magnified sample light 34 by detector 18. In certain embodiments, the process includes selectively communicating sample light 32 from image focal plane 9 to detector 18 and detecting sample light 32 by detector 18. In a particular embodiment, the process includes selectively communicating magnified sample light 34 from back focal plane 7 to detector 18 and detecting magnified sample light 34 by detector 18.

In some embodiments, a process for performing surface plasmon resonance imaging includes providing a high numerical aperture (NA) microscope objective and inverted microscope body, producing evanescent wave 28 at layer 12 (e.g., a thin metal coated on substrate 10) by coupling incident magnified transformed light 26 at the surface plasmon resonance angle of layer 12. It is contemplated that an angular position of the reflected resonance minimum is highly sensitive to changes of refractive index at the interface between substrate 10 and layer 12. Moreover, the refractive index is proportional to an amount analyte 40 adsorbed on a surface of layer 12. In an embodiment, the process is a label-free process for measuring protein and DNA affinity constants in an array format. Advantageously, surface plasmon resonance imaging with article 2 achieves near diffraction limited resolution for resolving features and structures for cell biology applications, fluid compositions, heterogeneous compositions, solid composition, and the like.

In an embodiment, again with reference to FIGS. 2, 3, 4, and 5, a process for acquiring a surface plasmon resonance image includes providing article 2 that includes digital light projector 50, providing incoherent white light as source light 20 from digital light projector 50, selecting a wavelength from the white light using a filter wheel as, and controlling digital light projector 50 with the controller, wherein the controller (e.g., a computer) controls spatial patterning and positioning of source light 20 to precisely control a position of transformed light on back focal plane 64 and consequently an angle of incidence of magnified transformed light 26 at image focal plane 68 to obtain the surface plasmon resonance angle and to maximize coupling of magnified transformed light 26 with surface plasmons and maximize production of evanescent wave 28. The process further includes adjusting the source optical profile by digital light projector 50, adjusting a polarization of source light 20 with polarizer 58 (e.g., a linear or radial polarizer), and producing transformed light 22 that includes a polarization different from source light 20, wherein a polarization of transformed light 22 is linearly polarized, radially polarized, elliptically polarized, circularly polarized, and the like (and specifically linearly or radially polarized). The source optical profile can have a shape such as an arc shape, ring shape, and the like that matches the transmission profile of back focal plane 64, based on a maximum for coupling magnified transformed light 26 to surface plasmons of layer 72. The process also includes magnifying (e.g., de-magnifying by one-third) source light 20 to produce transformed light 22 by lenses (54, 60), and projecting transformed light 22 onto back focal plane 64 of a back aperture of second objective lens 66. Additionally, the process includes acquiring the surface plasmon resonance image of sample 14 (not shown in FIGS. 2-5) disposed on layer 72 by detector 76.

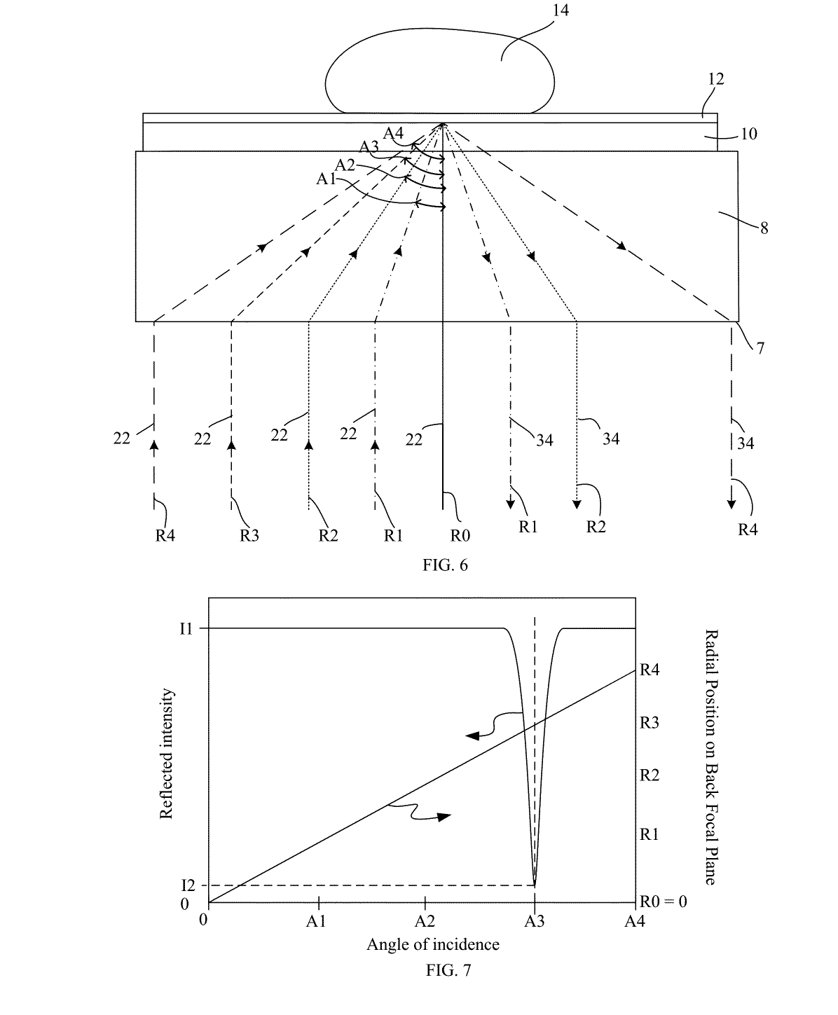

According to an embodiment, with reference to FIGS. 1 and 6, a position of transformed light 22 incident on back focal plane is adjusted by controlling light source 4 to produce source light 20 having a selected source optical profile. The source optical profile defines a radial position of transformed light 22 instant on back focal plane 7 of optical modifier 8 as shown in FIG. 6. Here, source light 20 can be selected such that transformed light 22 can be incident on back focal plane 7 at an arbitrary radial position such as a center of back focal plane 7 corresponding to radial position R0 or at other radial positions R1, R2, R3, R4, and the like. Accordingly, optical modifier 8 magnifies transformed light 22 into magnified transformed light that impinge on layer 12 disposed on substrate 10 at incident angles A1, A2, A3, A4 corresponding to incident to radial positions R1, R2, R3, R4 at back focal plane 7. Here, incident angle A3 corresponding to incident radial position R3 is the surface plasmon resonance angle, and incident angles A1, A2, A4 corresponding to incident radial positions R1, R2, R4 do not occur at the surface plasmon resonance angle and thus are reflected by layer 12 to produce magnified sample light 34 that appears that exit radial positions R1, R2, R4 at back focal plane 7. Interaction of their 12 with the magnified transformed light at incident angle A3 (the surface plasmon resonance angle) produces the evanescent wave that interacts with sample 14, and there is an absence of reflection of magnified transformed light from layer 12 at exit radial position R3. FIG. 7 shows a graph of reflected intensity and radial position on back focal plane versus angle of incidence for this design. It should be appreciated that a minimum of reflected intensity occurs at incident angle A3, which is the surface plasmon resonance angle at instant radial position R3.

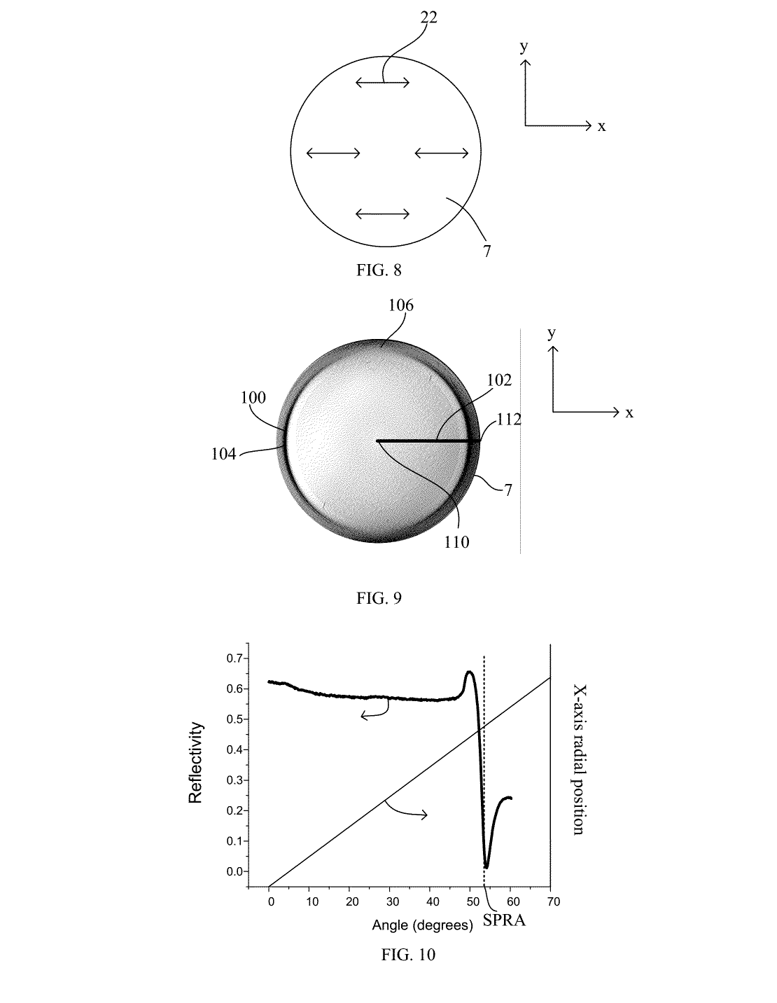

In an embodiment, light source 4 is the digital light projector. Here, the digital light projector is a spatial light modulator to pattern source light 20 for surface plasmon resonance imaging. A process for acquiring a surface plasmon resonance image includes controlling the digital light projector (DLP) to fully illuminate back focal plane 7 of optical modifier 8 (e.g., an objective lens) with transformed light 22 being monochromatic light. Selector 16 is interposed between optical modifier 8 and detector 18, and selector 16 projects the image on back focal plane 7 onto the camera CCD of detector 18. A homogeneous material is disposed on layer 12 as sample 14. In a particular embodiment, a gold-coated coverslip with a water-filled chamber is disposed via coupling fluid on optical modifier 8 at image focal plane 9. A shown in FIG. 8, transformed light 22 is incident on back focal plane 7 and polarized in the X-direction, i.e., transformed light 22 is linearly polarized along the x-direction with respect to back focal plane 7, which is referred to p-polarized. An image of back focal plane 7 is acquired by detector 18 as shown in FIG. 9, and surface plasmon resonance minima 100 is visible at the periphery of back focal plane 7 along the x-axis (at location 104) but not along y-axis (at location 106) of the reflected transformed light. A line scan (represented by line 102) is selected along the x-axis of the p-polarized light image from center 110 to periphery 112 of back focal plane 7 to provide reflectivity values as a function of angle of incidence as shown in FIG. 10, which is a graph of reflectivity and x-axis radial position versus angle. In this manner, the surface plasmon resonance angle (SPRA in FIG. 10) is determined. The surface plasmon resonance minima defines the transmission profile of back focal plane 7. It should be appreciated that source light 20 is produced with the source light profile that is substantially identical to the transmission profile such that the source light profile coincides with a shape of the surface plasmon resonance minima at back focal plane 7.

The source light profile is adjusted at the digital light projector to produce a crescent shaped source light 20 shown in FIG. 11 and being approximately 40 arc degrees when the transformed light is incident on back focal plane 7. The digital light projector is controlled to produce source light 20 such that the crescent shape is positioned where the surface plasmon resonance minimum was visualized when fully illuminated with non-patterned source light. A radial position of source light 20 then is adjusted slightly shallow of the surface plasmon resonance minimum to a reflectance minimum of ≈0.1 reflectance so that surface plasmon resonance imaging response of detector 18 is in a linear response range. In this manner, the digital light projector produces source light 20 having source light profile that matches the transmission profile for light in back focal plane 7. Lenses in selector 16 are changed to provide an image of image focal plane 9 onto detector 18 for surface plasmon resonance imaging.

In an embodiment, the digital light projector produces source light 20 that is subjected to polarization by a radial polarizer in optical transformer 6 to produce transformed light 22 having schematic radial polarization on back focal plane 7 as shown in FIG. 12. An image is acquired with the radial polarizer oriented in the radial direction in which the polarization is oriented towards the center of back focal plane 7, and the surface plasmon resonance minima is visible along an entire periphery back focal plane 7. The source light profile of source light 20 and transformed light 22 is changed to a thin ring shaped beam so that transformed light 22 on back focal plane seven has a circle shape as shown in FIG. 13. Accordingly, the source light profile is arbitrarily selected to match any transmission profile for the surface plasmon resonance minima.

It is contemplated that article 2 and processes herein has numerous advantageous benefits and properties. Source light 20 can be monochromatic or polychromatic. Source light 20 can be coherent, partially coherent, or incoherent. In some embodiments, source light 20 has a wavelength from 200 nm to 5000 nm. According to an embodiment, source light 20 and transformed light 22 independently comprise a wavelength from 200 nm to 5000 nm. Moreover, Optical modifier 8 is configured to conserve the source optical profile from receipt of transformed light 22 to communication of magnified transformed light 24 In a certain embodiment, optical modifier 8 is configured to conserve the sample optical profile from receipt of sample light 32 to communication of magnified sample light 34.

Article 2 beneficially resolves sub-micrometer cellular structures by surface plasmon resonance imaging to provide visualization of subcellular structures that are proximate to layer 12. Moreover, processes herein advantageously acquire surface plasmon resonance images in an absence of fluorescent labels or a presence of fluorescent labels.

Materials and operation an article for surface plasmon resonance imaging is disclosed in Peterson et al., “High resolution surface plasmon resonance imaging for single cells,” BMC Cell Biology 2014, 15:35, which is incorporated herein by reference in its entirety.

The articles and processes herein are illustrated further by the following Examples, which are non-limiting.

### EXAMPLES

### Example 1

### Surface Plasmon Resonance Imaging Article

A surface plasmon resonance imaging article was assembled and included portions of an inverted microscope (Olympus IX-70, Center Valley, Pa.) with modifications to include an illumination source that was a digital light projector (Dell 3300MP; Dell, Round Rock, Tex.) that controlled with a laptop computer using image presentation software (Power Point, Microsoft, Redmond, Wash.) to project specific curved- or crescent-shaped images onto regions of the back aperture, or filling the entire back aperture of the objective with the illumination. The projector lens was removed and replaced with a 4× objective (Edmund Optics, Barrington, N.J.). The focused light was collimated with an achromatic lens (f=60 mm) and directed through a bandpass filter (FWHM=10 nm; Thorlabs, Newton, N.J.), and a rotatable linear polarizer (Thorlabs). This polarized monochromatic light is directed into a customized tube lens (f=100 mm), through a filter cube mounted with a pellicle beam splitter (Thorlabs), and onto the back focal plane (BFP) of a high numerical aperture (NA) objective (100×, 1.65 NA, Olympus). From the focal lengths of the collimating lens and the tube lens, and the distances between them and the image plane, the magnification of the projected image onto the BFP of the objective was determined to be ⅓ according to the thin lens formula. The specific location of the shaped object on the computer screen controlled the corresponding position of the light shaped object on the BFP of the objective and subsequently the particular incident angle of the incident light on the gold coated coverslip (No. 0, Olympus). The coverslip and the objective were coupled with refractive index (n) matching fluid, n=1.78 (Cargille Laboratories, Cedar Grove, N.J.). The incident light coupled to the plasmons in the gold film and a fraction of the p-polarized light was reflected or absorbed depending on the angle of incidence. The reflected SPR image was directed out the microscope body, through a lens assembly that was positioned in or out of the beam and onto a 12-bit Coolsnap FX CCD camera (Roper Scientific, Tucson, Ariz.). The CCD camera imaged the back focal plane; with the lens assembly positioned in the optical path, the image plane was focused onto the CCD. The first lens of the assembly selected for the image plane, and the second lens adjusted the image magnification. Images were acquired from the CCD using Micro-Manager (www.micro-manager.org) open source microscopy software.

### Example 2

### Substrate Preparation

Coverslips (18 mm diameter, n=1.78, Olympus) were acid washed with 7:3 (v/v) H₂SO₄:H₂O₂, rinsed with 18 MΩ·cm distilled water, rinsed with ethanol, dried, and then coated with ≈1 nm chromium and ≈45 nm gold (99.99% purity) by magnetron sputtering using an Edwards Auto 306 vacuum system (Edwards, Wilmington, Mass.) at 1×10⁻⁷ mbar. For microsphere based experiments, a static fluidic chamber made out of polydimethylsiloxane (PDMS) was assembled on top of the coverslip, and the bare gold surface under distilled water was used as the substrate and media. For cell-based experiments, the gold coated coverslip was immersed in a 0.5 mmol/L hexadecanethiol solution in ethanol for 12 hours to generate a self-assembled monolayer. The coverslip was then inserted into a sterile solution of 25 μg/mL bovine plasma fibronectin (Sigma, St. Louis, Mo.) in Ca²⁺- and Mg²⁺-free Dulbecco's phosphate buffered saline (DPBS; Invitrogen, Carlbad, Calif.) for 1 hour.

### Example 2

### Cell Culture

Rat aortic vascular smooth muscle cell line, A10 (ATCC, Manassas, Va.), and mouse embryo fibroblast NIH 3T3 line (ATCC) were maintained in Dulbecco's Modified Eagles Medium with 25 mM HEPES (DMEM; Mediatech, Herndon, Va.) supplemented with nonessential amino acids, glutamine, penicillin (100 units/mL), streptomycin (100 μg/mL), 10% by volume fetal bovine serum (FBS) (Invitrogen, Carlsbad, Calif.); the human hepatocellular carcinoma Hep G2 and African green monkey kidney Vero lines (ATCC) were maintained in Eagle's Minimum Essential Medium (EMEM) containing 1.0 mM sodium pyruvate, 0.1 mM non-essential aminoacids, 1.4 g/L sodium bicarbonate (ATCC) supplemented with glutamine, penicillin (100 units/mL), streptomycin (100 μg/mL) and 10% by volume FBS . All cell lines were maintained in a humidified 5% CO₂ balanced-air atmosphere at 37 ° C. Cells were removed from tissue culture polystyrene flasks with 0.25% trypsin-EDTA (Invitrogen), and were seeded in culture medium onto the fibronectin coated substrates at a density of 1000 cells/cm². After 72 h incubation, cells on the substrates were washed with warm Hanks Balanced Salt Solution (HBSS; ICN Biomedicals, Costa Mesa, Calif.), fixed in 1% (v/v) paraformaldehyde(EMS, Hatfield, Pa.) in DPBS for 30 min at room temperature, quenched in 0.25% (m/v) NH₄Cl in DPBS (15 min) and rinsed with DPBS. After rinsing with DPBS, the fixed cell substrates were overlaid with a fluidic chamber made out of polydimethylsiloxane (PDMS) and kept under DPBS for all microscopy measurements.

### Example 3

### Polymer Microspheres

Polymer microspheres of various materials and sizes were obtained from the following sources: silica microspheres (refractive index (n)=1.42, diameter 6.1 μm; Bangs Laboratories, Inc., Fishers, Ind.), poly(methyl methacrylate) (PMMA) microspheres (n=1.48, diameter 63 μm to 75 μm; Cospheric, Santa Barbara, Calif.), Sephacryl S-300 microspheres (n=1.345 (estimate), diameter 25 μm to 75 μm; GE Healthcare Biosciences, Pittsburgh, Pa.), polystyrene-latex microspheres (n=1.59, diameter 43 μm; Beckman Coulter, Miami, Fla.), polystyrene-latex microspheres (n=1.59, diameter 5.7 μm; Molecular Probes, Inc., Eugene, Oreg.). In most cases, ≈100 μL of stock bead suspension was diluted 1/10 in distilled water. This dilution was centrifuged and then resuspended with 1 mL nanopure distilled water, repeated twice. A fraction of the distilled water-bead suspension was then added to a fluid chamber mounted on a gold coated substrate at room temperature. If the microspheres were shipped dry, the first step was to add a small volume, ≈50 μL, to a microfuge tube and resuspend in 1 mL distilled water. The green fluorescent microspheres (diameter (0.175±0.005) μm; Life Technologies, Grand Island, N.Y.) used to test instrument resolution were used as received in aqueous suspension.

### Example 4

### Phase Contrast, Bright Field, and Fluorescence Microscopy

Phase contrast microscopy images were acquired using a 20×, 0.4 NA, Ph1 objective (Olympus) on the same microscope used for surface plasmon resonance imaging (SPRI). The surface plasmon resonance (SPR) image was registered to the phase contrast image using 2 fiduciary marks according to the TurboReg plugin in the ImageJ software. The epi-fluorescence images of the polymer microspheres were acquired with a 100×, 1.65 NA objective, the excitation light was generated by the DLP fully illuminated using a 480 nm excitation filter (480 nm, FWHM=10 nm; Thorlabs). For emission collection, a FITC filter (530 nm, FWHM=43 nm; Thorlabs) was inserted into the lens assembly before the CCD. A micrometer scale reference was imaged under bright field conditions and used to calibrate the spatial dimensions of the pixels. Bright field imaging of polymer microspheres were performed in transmission mode using the same 100×, 1.65 NA objective as for SPRI.

### Example 5

### Fluorescence Staining and Imaging

### Example 6

### SPR Image Collection and Analysis

For SPR back focal plane (BFP) imaging, the digital light projector (DLP) was set to project non-patterned, white light illumination. The excitation wavelength was selected with a rotatable band-pass filter wheel (670 nm, 620 nm, 590 nm, 550 nm, 515 nm, 480 nm, FWHM=10 nm; Thorlabs). The lens assembly before the camera was switched out to project the image on the BFP onto the camera CCD. A homogeneous material sample, here a gold coated coverslip with a water filled chamber, was mounted via coupling fluid on the objective. An image was acquired with the linear polarizer oriented in the x-image direction, which we term the p-polarized light image, as the SPR minima is visible at the periphery of the BFP in the x-axis but not in the y-axis. A line scan of the region of interest (ROI) was selected along the x-axis of the p-polarized light image from the center to the periphery of the BFP provides reflectivity values as a function of angle of incidence. In other configurations, this information would be provided by a sequential angle scan. These intensities were normalized to reflectivity units from a SPR curve fit with a 3-layer Fresnel model using literature values for the optical constants of the layer involved (glass/gold/media).

Prior to SPR imaging of the specimen, the incident angle of light selection was optimized in the BFP. After mounting and aligning the sample, the DLP was set to fully illuminate the BFP with p-polarized light at selected wavelength as described above. The shape of the light projection was then changed to a thin crescent shaped beam of light of ≈40 arc degrees in the BFP circle. The crescent shape was initially placed near where the SPR minimum was visualized when fully illuminated with non-patterned light. Switching the image view from the BFP to the sample plane, using the microscope ocular or CCD camera, the crescent shape position was then finely tuned by translating the crescent shape in the x-direction in the BFP until the intensity value in the image plane was minimized. The minimum intensity value across the range of angles determined by the crescent is ≈0.05 reflectance. The crescent shape was then adjusted slightly shallow of the SPR minimum, to a reflectance minimum of ≈0.1 reflectance, to ensure that the subsequent SPR imaging response will be in the linear response range. In this way, by using the BFP image, one can obtain the reflectivity response versus incident angle over a range of angles simultaneously, and from the SPR sample plane one can obtain the average reflectivity value in the image intensity. For experiments on bare gold surfaces in distilled water, the incident angle for maximum SPR coupling was calculated to be ≈53.5° for 620 nm. The process of incident angle selection was performed for each selected wavelength.

For each SPR image in the sample plane a p- and s-polarized image was taken by rotating the linear polarizer 90° and using a crescent shape of light near the SPR minimum optimized as described above. Dividing the p- by s-polarized image reduces the effect of spatial inhomogeneity in incident light, a strategy adapted from a previous SPRI prism configuration. The resulting image was normalized to reflectivity units based upon an SPR angle scan. For subsequent analysis and comparison, the images were further modified to convert the reflectivity units into Δ-reflectivity (ΔR) by using ΔR=R₁−R₀ where a background ROI under water or buffer media is used to calculate Ro which is then subtracted from the rest of the image values, R₁, to convert to ΔR.

For determination of the measured radius of microspheres in the SPR images, a script was written in ImageJ that uses a manually selected circular ROI approximately centered on the microsphere. The ROI extends several micrometers from the detectable outside edge of the microsphere. The circle diameter was then dilated by 10 μm and all pixel values between the two circled areas were used to calculate the standard deviation (σ) of the image background. A threshold with a value of 3σ was used to delineate background; the number of pixels above the threshold was used to compute the area and radius of the microsphere object within that area.

The evanescent wave decay profile was calculated by a single exponential decay function I(z)=I₀ e^{(-z/lp)} where z is the distance perpendicular from the surface and the initial intensity I₀=1. The penetration depth at 1/e (lₚ) is calculated according to the formula for surface plasmon penetration depth with published optical properties for gold and water for each wavelength measured here (670 nm, 620 nm, 590 nm, 550 nm, 515 nm, 480 nm). Image analysis was performed using ImageJ software (http://rsb.info.nih.gov/ij/). Angle dependent SPR data were analyzed using stock and custom code written in MATLAB (Mathworks, Natick, Mass.).

### Example 7

### Back Focal Plane Imaging and Excitation Angle Selection

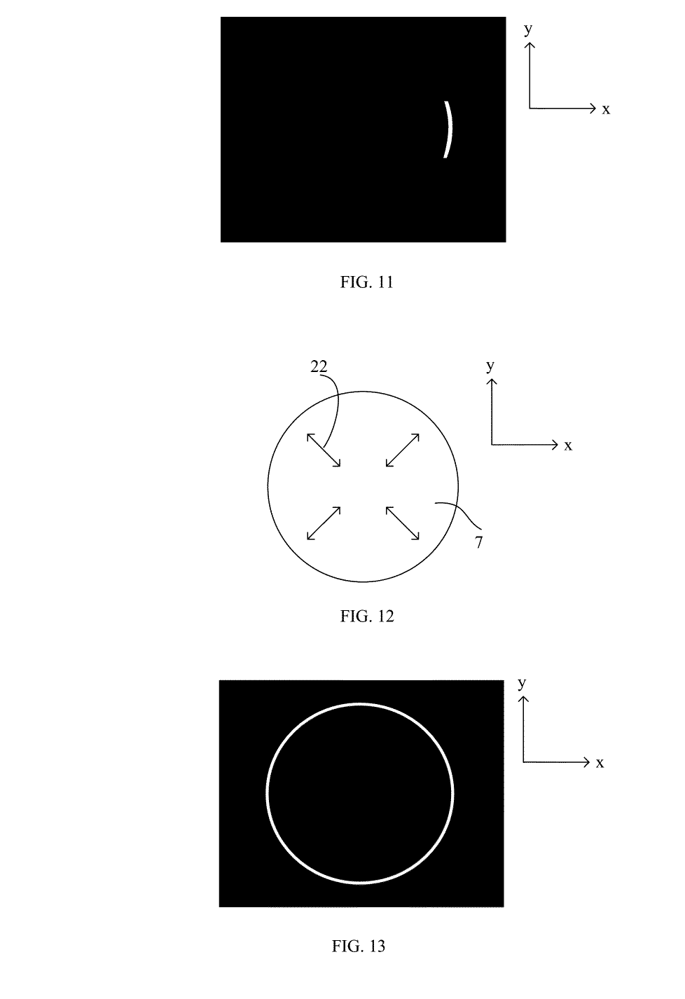

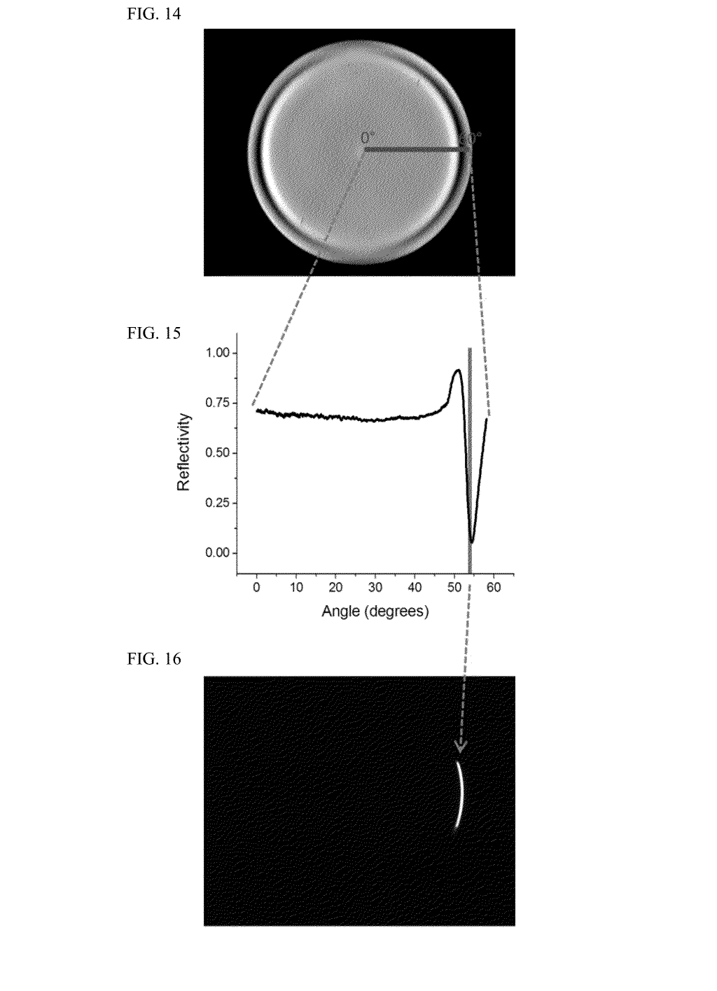

The spatial location of light at the back focal plane (BFP) of the microscope objective indicated the incident angle with which that light impinged on the sample. The angle of incidence increased approximately linearly with distance from the optical axis of the objective. For example, an illuminated spot in the center of the BFP irradiated the sample normal to the surface while a laser spot at the edge of the objective BFP illuminated the sample at an angle that was steep enough to achieve total internal reflection. FIG. 14 shows the image of the BFP that is fully illuminated by the reflection of 620 nm from a 45 nm thick gold coating on a glass coverslip in buffer. The incident light was linearly polarized, and impinged on the sample at angles that varied from 0° at the center of the BFP to an angle of 60° at the periphery. This angle span was marked by the line shown in FIG. 14. The regions of lowest intensity, which appeared as the dark ring at the periphery of the BFP, occurred at the angle of incidence where the light was maximally coupled with the surface plasmons, and minimum reflectance occurred. This angle was ≈53.5°. The strong plasmon absorbance of the p-polarized light occurred in the x-direction and faded away azimuthally as the light became entirely s-polarized in the y-direction.

A line scan from the center to the periphery of the BFP captured the angular dependence of the surface plasmon resonance, and this dependence is shown in FIG. 15. This angle scan was fit by and had good agreement with a 3-layer Fresnel model assuming published values for the prism/gold/water interface. The vertical line represented the angle (≈53.5°) of excitation used for SPR imaging at 620 nm.

FIG. 16 shows the shape of the reflected light from the BFP when patterned illumination was provided by the DLP to achieve maximum surface plasmon excitation. The shape of the excitation light projected onto the BFP for SPR coupling at ≈53.5° was a crescent shape arc of light that spanned ≈40° azimuthal (essentially identical to the reflected image shown). The selection of the characteristics of this crescent shaped pattern of incident light for SPR imaging was the result of an optimization study for image quality and contrast. Increasing the radial width of the crescent beyond a certain amount decreased the image contrast. The azimuthal length of the crescent arc appeared to control image quality: lengthening the crescent resulted in lower background noise, up to limit, ≈40°, whereupon increased length then decreased image contrast. Both of these effects were likely caused by an increase in background signal by rays that did not contribute to the useful SPR signal at a specific incident angle. Shortening the crescent shape decreased image quality and eventually resulted in the appearance of rings, interference patterns, and background unevenness characteristic of coherent laser light illumination sources.

### Example 8

### SPR Imaging of Cells

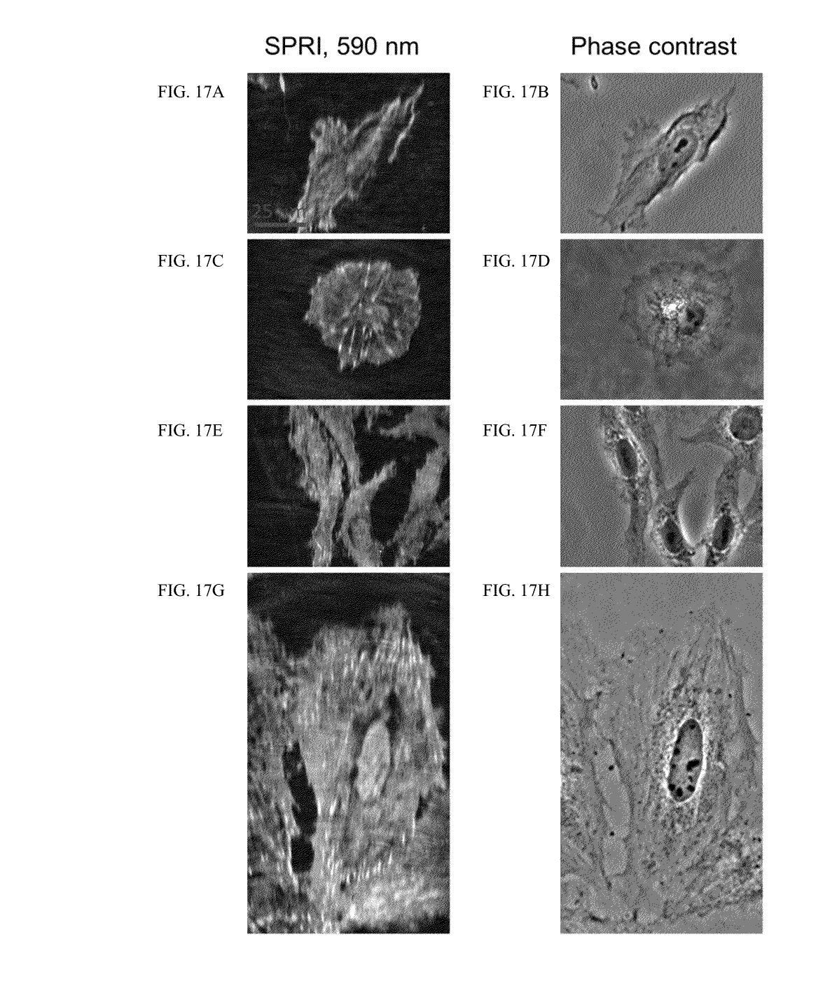

FIGS. 17A, 17C, 17E, and 17G show SPR images of four selected cell types: mouse fibroblast cells (3T3), human liver carcinoma cells (HepG2), kidney epithelial cells (Vero), and vascular smooth muscle cells (A10). FIGS. 17B, 17D, 17F, and 17H show phase contrast images of four selected cell types: mouse fibroblast cells (3T3), human liver carcinoma cells (HepG2), kidney epithelial cells (Vero) and vascular smooth muscle cells (A10). The selected cell types were seeded and fixed after 72 h on a fibronectin coated substrate as described in Example 2.

The SPR images were taken with 590 nm incident light and showed high optical contrast of the cell-substrate interface with a spatial resolution sufficient to reveal a number of subcellular features. The brighter regions of the interest were areas where the density of dielectric material was greater, which resulted in greater reflectivity of the incident light due to reduced plasmon coupling. The optical contrast was measured in reflectivity units that have a direct relationship to the mass and refractive index of material within the evanescent wave. Since values used for refractive index for proteins and lipids are usually similar, the difference in mass was likely the primary source of contrast. However, because the thickness of the cell was much larger than the depth of penetration of the evanescent wave, the reflectivity contrast was determined by the distance between the cell components and the surface.

The optical contrast in the SPR images was sufficient to define the edge of the cell with relatively high signal-to-noise and this facilitates image segmentation of the cell object. SPR images showed punctuate regions of high reflectivity that were putatively the cellular focal adhesions. Cytoskeletal structure appeared to be visible especially in the A10 image. There were lower intensity regions visualized within the cell that indicated regions of either lower protein density or greater distance from the substrate.

The different cell types presented different features when observed with SPRI. For some of the cell types shown (Vero, A10), the SPR images allowed visualization of the nucleus of the cell. The ability to visualize the nucleus indicated that it was sufficiently close to the cell-substratum interface such that it was in the evanescent field; and that the nucleus contained sufficient density of proteins and nucleic acids as to have a refractive index that was distinct from the cytoplasm as to be distinguishable.

Phase contrast images shown in FIGS. 17B, 17D, 17F, and 17H were observed by traditional widefield microscopy for comparison.

### Example 9

### Lateral Resolution of the High Resolution SPR Imaging System

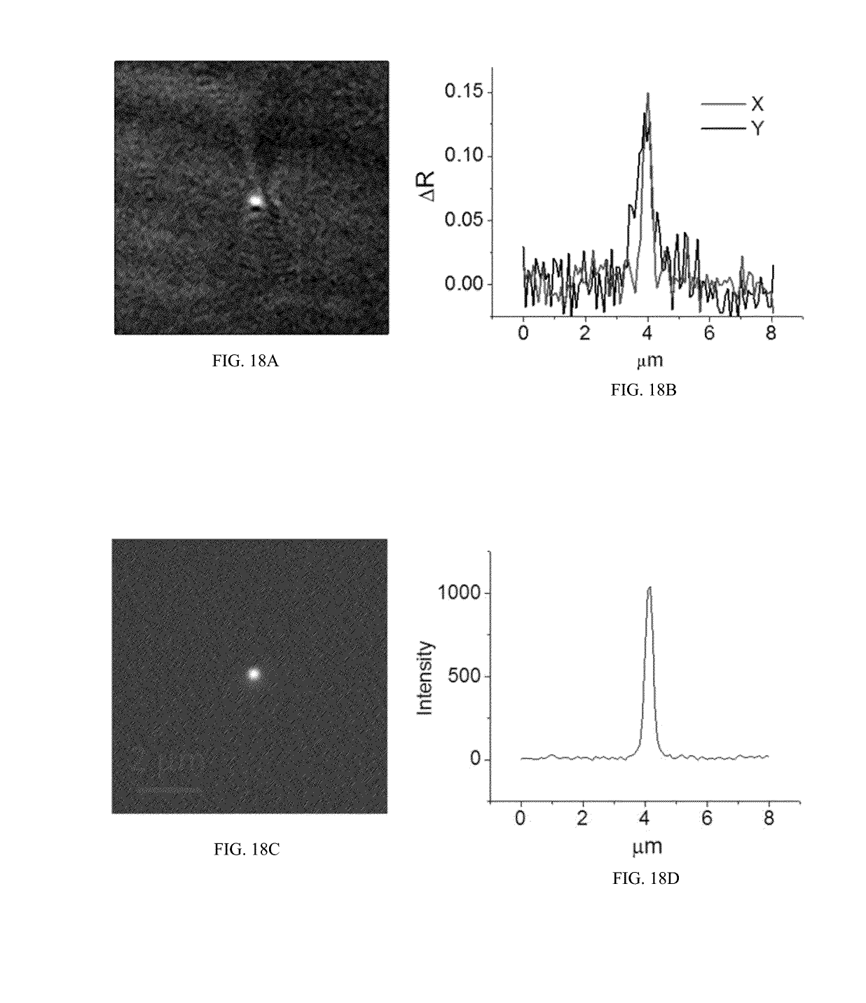

The theoretical diffraction-limited resolution for a 1.65 NA microscope objective is 0.23 μm and 0.20 μm for 620 nm and 530 nm light, respectively. The theoretical propagation length for 620 nm light of the surface plasmon in the direction parallel to the surface plasmon excitation is ≈3 μm. We measured the spatial resolution of our microscope using fluorescent nanoparticles to determine the point spread function in both epifluorescence and SPR imaging mode. We chose the fluorescence wavelength to be distinct in both excitation and emission wavelengths from the SPR imaging wavelength, and we chose the SPR wavelength for its observable lateral decay length. The fluorescent nanoparticles were measured at 530 nm emission under water in epi-fluorescent mode (FIGS. 18C and 18D), and a line profile plot was used to determine a full width at half maximum (FWHM) value of 0.29 μm, very close to the theoretical limit. For the second measurement, the SPR excitation light was set to 620 nm with ≈53.5° incident angle and the nanoparticle bead image was obtained, FIGS. 18A and 18B, with the corresponding line profile resulting in a FWHM of 0.30 μm in the x-direction perpendicular to the surface plasmon propagation vector, and 0.60 μm in the y-direction, parallel to the surface plasmon propagation. Asymmetry in the x- versus y-resolution arose from the surface plasmon leakage radiation decay in the direction parallel to the excitation light.

### Example 10

### Determining the Effective Penetration Depth of the SPR Evanescent Field

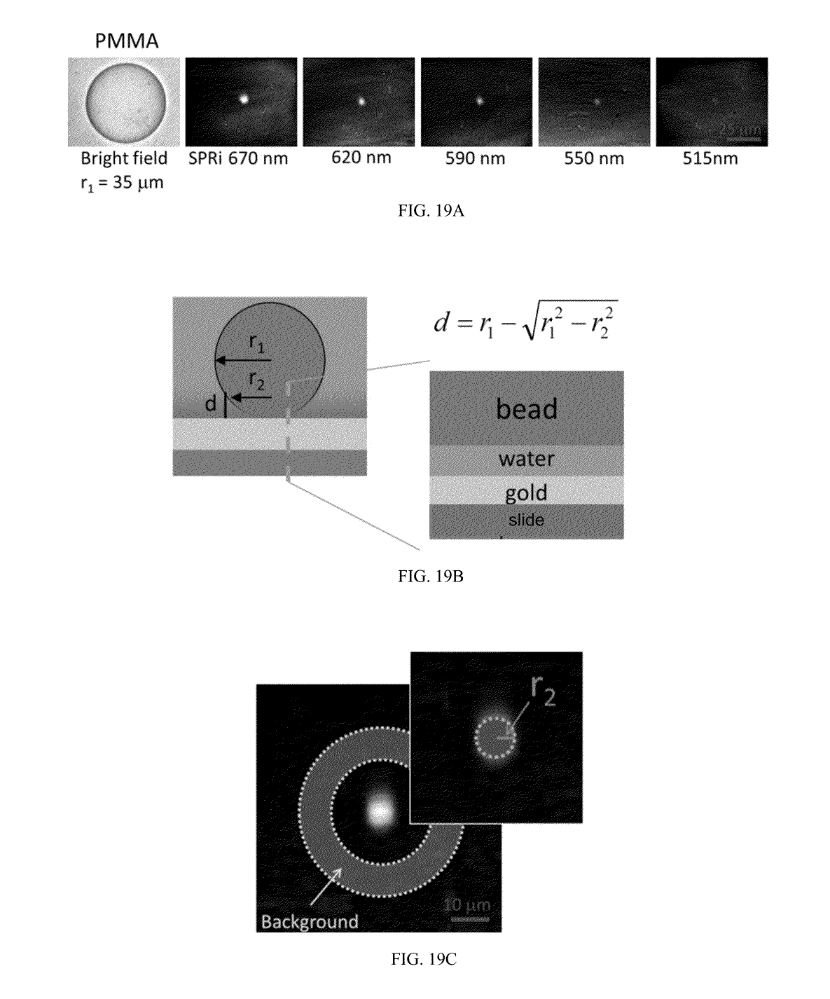

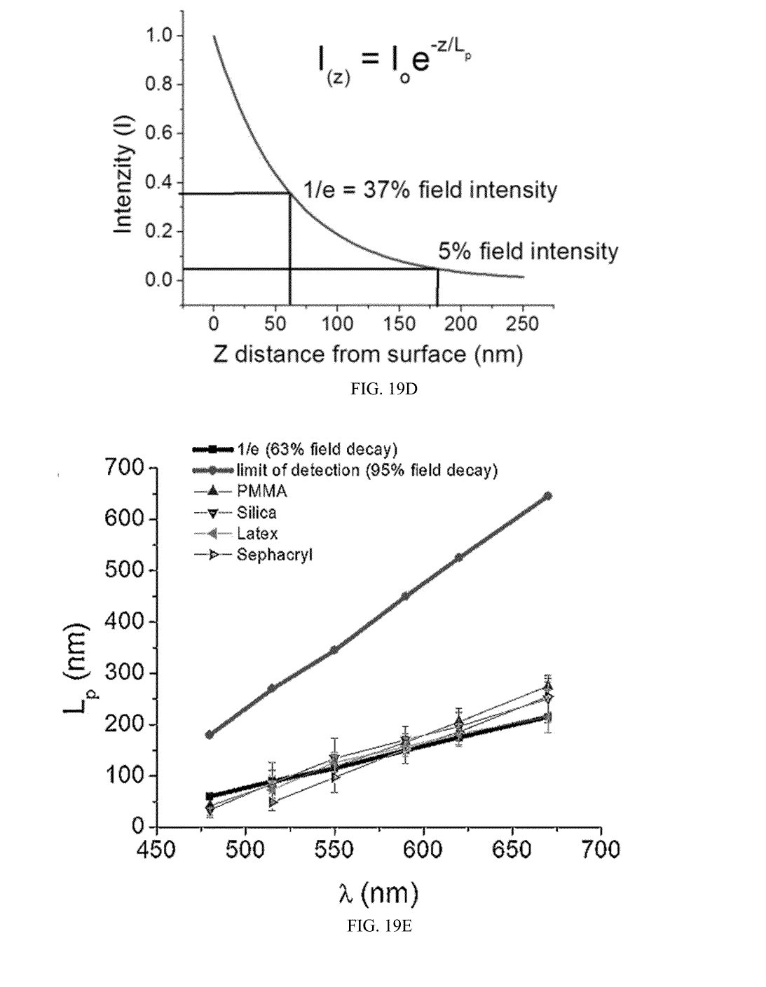

To measure directly the sensitivity of the SPR field as a function of distance from the surface, we employed measurements of polymer microspheres with known refractive index and diameter, and incident light of several wavelengths. Images of a representative poly(methyl methacrylate) (PMMA) microsphere were taken in bright field as well as with SPR imaging at several wavelengths (FIG. 19A). The radius of the microsphere r₁, measured in the bright field image, was related to the radius observed in the SPR image, r₂, and to the measured detectable penetration depth, d with the following equation , r₁²=r₂²+(r₂−d)², derived from the geometric Pythagoras theorem (FIG. 19B).

The physical picture is that only a small portion of the bead was in contact with the gold sensor surface, while most of the bead was above the surface, and above the surface plasmon generated evanescent wave. As the evanescent wave extended into the water media, the bead, which had a measurably different refractive index from water, was partially sampled by the evanescent wave. The distance at which the refractive index change due to the presence of the bead was detectable above the background was the threshold that we interpreted as the detectable extent of the surface plasmon penetration depth. FIG. 19C shows a plot summarizing the image analysis routine as described in Example 6), to determine the penetration depth values. For each SPR image, the background region of the image was used to determine the standard deviation (σ) of background noise. Intensity values of 3σ from the average background intensity were considered to be signal resulting from detectable bead material in the evanescent field. The r₂ value was obtained from the apparent area of the object in the SPR image estimated as a circle. The SPR penetration depth for each wavelength was determined using the r₂ value obtained for each SPR image, along with the r₁ value obtained for the bead diameter measured from the bright field image. FIG. 19D shows a theoretically calculated SPR evanescent wave intensity decay, described by a single exponential decay function, as a function of distance from the surface for 620 nm excitation light. This plot also indicates the distance from the surface where the field decays to 1/e of its original intensity or 37% field intensity, and where the field decays to 5% field intensity, which represented the theoretically maximum distance to detect a change of refractive index.

FIG. 19E shows a compilation plot that depicts the calculated penetration depth and detection threshold for a range of SPR excitation wavelengths, and is also plotted with the measured detectable penetration depths for several types of polymer microspheres over the same range of wavelengths. The measured limit of detection, within the experimental noise, is described by the theoretically determined distance at which the evanescent field decays to 1/e (63%). This occurred for a variety of polymer microspheres with differing refractive index values (n=1.345 to 1.59). Hence, the subcellular structures observed in the SPR images likely resided within a distance from the surface up to a maximum amount as described by the 1/e distance threshold.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

Reference throughout this specification to “one embodiment,” “particular embodiment,” “certain embodiment,” “an embodiment,” or the like means that a particular feature, structure, or characteristic described in connection with the embodiment is included in at least one embodiment. Thus, appearances of these phrases (e.g., “in one embodiment” or “in an embodiment”) throughout this specification are not necessarily all referring to the same embodiment, but may. Furthermore, particular features, structures, or characteristics may be combined in any suitable manner, as would be apparent to one of ordinary skill in the art from this disclosure, in one or more embodiments.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, the conjunction “or” is used to link objects of a list or alternatives and is not disjunctive; rather the elements can be used separately or can be combined together under appropriate circumstances. It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. An article to perform surface plasmon resonance imaging comprising:
a light source to provide source light, the source light comprising a source optical profile, the source optical profile being selected to match a transmission profile at a surface plasmon resonance angle;
an optical transformer configured to:
receive the source light from the light source; and
produce a transformed light comprising the source optical profile; and
an optical modifier comprising:
a back focal plane disposed at a first surface of the optical modifier and comprising the transmission profile; and
an image focal plane disposed at a second surface of the optical modifier opposing the back focal plane, the optical modifier being configured to:
magnify the transformed light; and
produce magnified transformed light comprising the source optical profile.

2. The article of claim 1, wherein the optical modifier further is configured to:
communicate the magnified transformed light from the back focal plane to the image focal plane; and
focus the magnified transformed light onto the image focal plane such that the magnified transformed light is incident at the image focal plane at the surface plasmon resonance angle.

3. The article of claim 2, further comprising:
a substrate; and
a layer disposed on the substrate,
wherein the substrate is configured to:
receive the magnified transformed light from the optical modifier, and
communicate the magnified transformed light to the layer, and
the layer is configured to:
produce an evanescent wave in response to receiving the magnified transformed light at the surface plasmon resonance angle, and
reflect light incident at the image focal plane at an angle different than the surface plasmon resonance angle.

4. The article of claim 3, further comprising a sample disposed on the layer to interact with the evanescent wave from the layer.

5. The article of claim 4, wherein the sample is configured to produce a sample light comprising a sample optical profile in response to interacting with the evanescent wave from the layer.

6. The article of claim 5, wherein the optical modifier is configured to receive the sample light.

7. The article of claim 6, wherein the optical modifier is configured to magnify the sample light and to communicate a magnified sample light.

8. The article of claim 7, further comprising a detector to receive the magnified sample light from the optical modifier.

9. The article of claim 1, wherein the optical transformer comprises a first objective lens, a collimating lens, a filter, a polarizer, a tube lens, a beam splitter, or a combination comprising at least one of the foregoing.

10. The article of claim 1, wherein the optical modifier comprises a second objective lens.

11. The article of claim 1, wherein the light source comprises a digital light source, an analog light source, or a combination comprising at least one of the foregoing.

12. The article of claim 1, wherein the transmission profile comprises an asymmetric shape, and the light source is configured to produce the source light such that the source optical profile is asymmetric to match the transmission profile.

13. The article of claim 1, wherein the transmission profile comprises an symmetric shape, and the light source is configured to produce the source light such that the source optical profile is symmetric to match the transmission profile.

14. The article of claim 3, wherein the optical modifier is configured to conserve the source optical profile from receipt of the transformed light to communication of the magnified transformed light.

15. The article of claim 7, wherein the optical modifier is configured to conserve the sample optical profile from receipt of the sample light to communication of the magnified sample light.

16. The article of claim 1, wherein the source light and the transformed light independently comprise a wavelength from 200 nm to 5000 nm.

17. The article of claim 1, wherein the source light and the transformed light independently comprise a duty cycle from 0% to 100%.

18. A process for modifying a source light, the process comprising:
receiving a source light comprising a source optical profile at an optical transformer;
producing a transformed light comprising the source optical profile;
communicating the transformed light from the optical transformer to an optical modifier that comprises:
a back focal plane; and
an image focal plane opposing the back focal plane;
magnifying the transformed light;
producing a magnified transformed light comprising the source optical profile from the transformed light to modify the source light; and
transmitting the magnified transformed light at a surface plasmon resonance angle at the image focal plane.

19. The process of claim 18, further comprising:
communicating the magnified transformed light to a layer disposed on a substrate;
producing an evanescent wave from the layer from the magnified transformed light at the surface plasmon resonance angle;
subjecting a sample disposed on the layer to the evanescent wave;
producing a sample light comprising a sample optical profile from the sample in response to being subjected to the evanescent wave; and
communicating the sample light to the optical modifier.

20. The process of claim 19, further comprising:
producing a magnified sample light comprising the sample optical profile from the sample light by the optical modifier;
communicating the magnified sample light from the optical modifier; and
receiving the magnified sample light by a detector.
